(19) United States
(12) Patent Application Publication
(10) Pub. No.: US 2021/0374866 A1
(43) Pub. Date: Dec. 2, 2021

(54) Integrated Database Systems with Intelligent Methods and Guidance for Financial Margin Expansion

(71) Applicant: Margin Expansion Solutions, LLC, Charlotte, NC (US)

(72) Inventors: Ajay Garg, Charlotte, NC (US); Richard Erroll DeVaughn, Charlotte, NC (US); Sanjay Kumar Sai, Charlotte, NC (US)

(21) Appl. No.: 17/327,156

(22) Filed: May 21, 2021

Related U.S. Application Data
(60) Provisional application No. 63/030,389, filed on May 27, 2020.

(51) Int. Cl. G06Q 40/06; G06F 16/25; G06N 20/00; G06Q 10/06

(52) U.S. Cl. CPC G06Q 40/06; G06F 16/252; G06Q 10/06375; G06N 20/00; G06F 16/254

(57) ABSTRACT

An integrated database system with intelligent methods and guidance for financial margin expansion is provided. The integrated database system includes a host computer, an enterprise client database system accessible to the host computer and an analytics and reports module communicating with the host computer and the enterprise client database systems. The information stored on the host computer may be dynamically updated as per changes in the enterprise client database system and manual input. Pre-processed Margin Expansion Solution (MES) Database data is input as training data for Al based algorithms and Insights. Through application of a Learning Algorithm, MES Models are created which produces Predicted Data for artificial intelligence and predictive machine learning process.

### CROSS-REFERENCE TO RELATED APPLICATIONS

This application claims the benefit of U.S. Provisional Patent Application No. 63/030,389, filed May 27, 2020, entitled “Integrated Database Systems with Intelligent methods and guidance for financial Margin Expansion. A data management System includes a host computer, another enterprise client database system accessible to the host computer and an Analytics and Reports module communicating with the host computer and the enterprise client database system. The information Stored on the host database computer is dynamically updated as per changes in the enterprise client database system and manual input,” which is incorporated herein by reference in its entirety.

### TECHNICAL FIELD

This present application relates generally to business intelligence systems and in particular to an integrated database system.

### BACKGROUND

Current business tools and processes such as, for example, workbooks, project plans, and in-house custom programs for managing ongoing strategic initiatives are inadequate by failing to provide meaningful information and insights for successful completion of the initiatives. Typically, businesses manage and execute two operating plans. One operating plan is annual, which includes annual operating plans having outcomes of: Profit and Losses (P&L) and Earnings Before Interest, Taxes, Depreciation, and Amortization (EBITDA). EBITDA gives an indication of the current operational profitability of the business and allows a comparison of profitability between different companies after removing out expenses that can obscure how the company is really performing. Another operating plan is Multi Year Strategic including strategic operating plans having an outcomes of market position and/or Compound Annual Growth Rate (CAGR) which is the rate of return that would be required for an investment to grow from its beginning balance to its ending balance, assuming the profits were reinvested at the end of each year of the investment's lifespan.

According to a recent survey conducted by a leading business management firm, 90% of surveyed companies had strategic cost reduction initiatives, 75% did not achieve their cost productivity targets, and 44% missed their cost productivity goals by more than 50%. There are many drivers and shortcomings of current business tools and processes. For example, management at a functional level is perceived as a functional process, therefore management at a functional level does not rise to business critical. Further, shortcomings of current business tools and processes include manual and tedious portfolio management, with consequent loss of data fidelity. Also, another shortcoming of current business tools and processes include ongoing initiatives databases that are not integrated with enterprise financial and operations databases. Information from other databases is extracted manually which is error prone, has resource constraints, and needs specialists, i.e. conventional Enterprise Resource Planning (ERP) systems are not well suited to end-user navigation. Furthermore, there is difficulty in maintaining information at current level, which leads to poor assumptions and decisions and loss of credibility of the data/initiatives. There are also poor reporting structure/dashboards which leads to a lack of organizational visibility through appropriate metrics and insights for leadership. Without easy information access, and the means to quickly analyze and report on findings, users can overlook important business correlations or veer off-track completely. Ultimately, the lack of analytics does not provide leadership the overview of progress and directional recommendations using data analytics tools, and the quality and speed of decision-making suffers.

Many large organizations use ERP systems as a P&L Management Platform to consolidate day-to-day transaction data and streamline business functions such as receiving & executing sales demand, optimizing cash outlay for operations, accounting compliance for regulators, financial P&L reporting to shareholders. Currently, there are no enterprise level platforms to manage strategic programs. Some information/data needed for strategic programs resides in ERP but ERP data base and modules are designed for managing commercialized SKUs and for keeping the ‘lights on’. With their predefined, standard reporting capabilities, however, these ERP systems are not optimized for managing strategic ‘in-flight’ programs (current programs). Further shortcomings of current tools and processes include: management by an individual/function, which is perceived as a functional tool, and does not rise to business critical; tedious portfolio management requiring a high frequency of manual input, and a natural tendency to lose fidelity; database not integrated with ERP, that is, information from other databases is extracted manually, and subject to getting corrupted; timing of information which lags due to manual extraction and sub enterprise level planning; poor reporting structure and interactive dashboards, meaning lack of appropriate metrics and insights for leadership; and lack of analytics which does not provide leadership directional recommendations.

Current business tools and processes in use for Current Strategic Portfolio Management Tools are, for example, Spreadsheet workbooks, Microsoft project, and In-house custom programs. Shortcomings of current tools & processes include: time consumption for the entire manual process which is approximately 2 to 3 weeks; managed by an individual/function which is perceived as a functional tool, does not rise to business critical; tedious portfolio management which has a high frequency of manual input, natural tendency to lose fidelity; data base not integrated with ERP while information from other databases is extracted manually, subject to getting corrupted; timing of information is lagging due to manual extraction & sub enterprise level planning; poor reporting structure/dashboards which leads to a lack of appropriate metrics & insights for leadership; and lack of analytics which does not provide leadership directional recommendations.

Requirements of proper portfolio management include enterprise level data base ownership; the current state of conventional portfolio management however is Individual function. Further shortcomings of proper portfolio management include: portfolio management which is manual and lagging; financial data which is currently manually extracted from databases; database fidelity which is low and easily corrupted; Reporting/Dashboards which are generic and generally not relevant for stakeholders; Business Intelligence which is subjective and not targeted for stakeholders; portfolio status which is lagging and out of phase with enterprise; scalable, however is currently difficult to roll across enterprise; decision and risk management which currently has low confidence; not sustainable with the process open to subjective modification; and dashboards filtering and refresh display having a high latency of approximately 20-30 seconds. Further, currently few cost programs hit their targets. For example, 90% of companies surveyed have a cost program, however 75% of companies do not achieve cost productivity targets and 44% miss productivity targets by more than 50%.

Therefore, there is a need for affordable integrated database system with Intelligent methods and guidance for financial margin expansion technology, which an enterprise level database and platform with intelligent modules can use to achieve, manage, and maintain a complete view of its operational and financial effectiveness, customer relationships, and supply-side activities for business and functional leaders to make decisions with current information and high confidence, resulting in program success rates higher than current state. Further, there is a need to address the above current state shortcomings of portfolio management. Further still, as databases may be excessively large and slow to process, there is a need to save disk space, reduce redundancy, and increases processing speed of the analytics as compared to conventional data platforms. MES Smart Analytics provide business leaders and stakeholders visibility to a dynamic, smart, data and facts-based platform for early interventions, corrective actions, and decisions to achieve market beating profitability. MES unlocks the energy of an organization to enable best in class, sustainable and predictable performance. MES Analytics also saves disk space, reduces redundancy, and increases processing speed of the analysis of databases as compared to conventional data platforms.

### SUMMARY

The present application solves one or more of the above-mentioned problems and removes all current state shortcomings above and provides an enterprise level data base with intelligent modules for business and functional leaders to make decisions with real time and current information with high confidence, dramatically improving Margins and financial results. In one embodiment of the present application, a configurable, Integrated Database System is provided. This Integrated Database System is rich and complete enough to be used by many organizations. The Integrated Database System is also configurable to a particular organization. The initial steps of creating Integrated Database System are manifested in this system. The configuration of the Integrated Database System takes substantially less time to do than creating a database from scratch. Thus, time and expenses are saved with this present application.

In another embodiment of the present application, a Margin Expansion Solution (MES) Data Platform Architecture is described which implements the integrated database system and provides an enterprise level data base with cross functional intelligent modules for business and functional leaders to make decisions with high assurance and accuracy, dramatically improving initiative outcomes and business results.

In accordance with an aspect of the invention, an integrated database system for margin expansion solution is provided. The integrated database system includes a client computer; a host computer communicatively connected to the client computer; an enterprise database accessible by the client computer, the enterprise database storing business data; a margin expansion solutions (MES) database populated by automatically extracted data from the enterprise database by a data extraction module, and further populated with ongoing initiatives information, wherein financial and operational data is automatically extracted from business data of the enterprise database according to the ongoing initiatives information; an analytics module that analyzes the extracted financial and operational data; and a reports module that provides reports and dashboards for a user in a relevant format based on the analyzed financial and operational data; wherein the integrated database system has ubiquitous access which reduces an amount of time required for information gathering, formatting, analyzing and reporting, from a manual process to an automated process with real time reports and dashboards, including predictive and prescriptive insights.

In accordance with another aspect of the invention, a method for margin expansion solution is provided. The method includes inputting, by a client computer, business data into an enterprise database; populating, by a host computer, a margin expansion solutions (MES) database with ongoing initiatives information; extracting, by a data extraction module, data from the enterprise database and populating the MES database; extracting automatically, by the MES database, financial and operational data from the business data of the enterprise database according to the ongoing initiatives information; analyzing, by an analytics module, the extracted financial and operational data; and providing, by a reports module, reports and dashboards for a user in a relevant format based on the analyzed financial and operational data; wherein the integrated database system has ubiquitous access which reduces an amount of time required for information gathering, formatting, analyzing and reporting, from a manual process to an automated process with real time reports and dashboards, including predictive and prescriptive insights.

In accordance with another aspect of the invention, an MES data platform architecture system is provided. The MES data platform architecture system includes a client computer including a database source; a host computer including cloud storage, the host computer communicatively connected to the client computer; a cloud data platform accessible by the host computer, the cloud data platform storing business data, wherein the cloud data platform includes: staging tables, streams, and tasks, and an MES database module populated with ongoing initiatives information, wherein financial and operational data is automatically extracted from the business data of the enterprise database according to the ongoing initiatives information, and wherein the MES database module is kept current without manual intervention, an analytics module that analyzes the extracted financial and operational data, and a reports module that provides reports and dashboards for a user in a relevant format based on the analyzed financial and operational data; and a data visualization module that displays the reports and dashboards; wherein the MES data platform architecture system has ubiquitous access which reduces an amount of time required for information gathering, formatting, analyzing and reporting, from a manual process to an automated process with real time reports and dashboards, including predictive and prescriptive insights.

The MES Module implemented by the integrated database system addresses all strategic program failure drivers. For example, the MES Module implemented by the integrated database system provides data & facts-based visibility in the right format for leaders to make early interventions, corrective actions and decisions. That is, MES Module analytics prevents weak business cases to go into execution. MES Module monitoring enables early intervention in erosion of savings due to unrealistic target setting. MES Module extracts financial data from ERP and prevents lack of Efficient Financial Reporting. MES Module provides Reporting & Tracking designed for all business levels and prevents poorly designed reporting and tracking. MES Module provides data and fact-based transparency and helps prevent lack of buy-in of the solution by the stake holders. MES module provides business intelligence and artificial intelligence-based recommendations and prevents management challenges in implementing initiatives.

### BRIEF DESCRIPTION OF THE DRAWINGS

Embodiments of the present application will now be described with reference to the accompanying drawings, in which:

FIG. 1 shows a diagram of a component overview of a current database system providing a current workstream of margin expansion portfolio management. A current database system is described and provides a current workstream of margin expansion portfolio management

FIG. 2 shows a diagram of a component overview of an integrated database system providing a current and future workstream of margin expansion portfolio management with intelligent methods and guidance for financial margin expansion.

FIG. 3 shows a diagram of a component overview of an integrated database system providing a future workstream of margin expansion portfolio management.

FIG. 4A shows a diagram of a component overview of an MES Data Platform Architecture implementing the integrated database system with intelligent methods and guidance for financial margin expansion.

FIG. 4B shows a component overview of an ERP System of the MES Data Platform Architecture.

FIG. 4C shows a component overview of an MES Analytics Database of the MES Data Platform Architecture.

FIG. 4D shows a component overview of Data Visualization of the M ES Data Platform Architecture.

FIG. 5A shows a diagram of a component overview of a portion of an MES Smart Process and Decision flow with intelligent methods and guidance for financial margin expansion.

FIG. 5B shows a diagram of a component overview of a portion of an MES Smart Process and Decision flow with intelligent methods and guidance for financial margin expansion.

FIG. 5C shows a diagram of a component overview of a portion of an MES Smart Process and Decision flow with intelligent methods and guidance for financial margin expansion.

FIG. 6 shows a diagram of a component overview of an AI & machine and learning overview.

FIG. 7 shows a business portfolio management chart shows including current requirements, current state of business process and tools and the MES provided solutions by implementing the integrated database system.

FIG. 8 shows a diagram illustrating elements or components that may be present in a computer device or system configured to implement a method, process, function, or operation in accordance with an embodiment of the present application.

### DETAILED DESCRIPTION

In this description, the term business will be used to denote both commercial affairs and organizational affairs. The term integrated database system will be used to denote a system implemented for the financial margin expansion of the performance of an organization. The organization may be commercial or non-commercial. An integrated database system may include a database that is rich and complete enough to be applicable to many organizations and configurable to a specific organization. The term CEO, CFO, may be used to denote a user using or implementing the process, system, and/or method. The integrated database system further includes a host computer, an enterprise client database system accessible to the host computer and an analytics and reports module communicating with the host computer and the enterprise client database systems. The information stored on the host computer may be dynamically updated as per changes in the enterprise client database system and manual input. The term integrated database system also relates to a business performance management system, including a business model and a query engine tool. The term business model in an integrated database system relate to a business performance management model in a business performance management system. The term business performance management refers to the measurement and management of the performance of an organization.

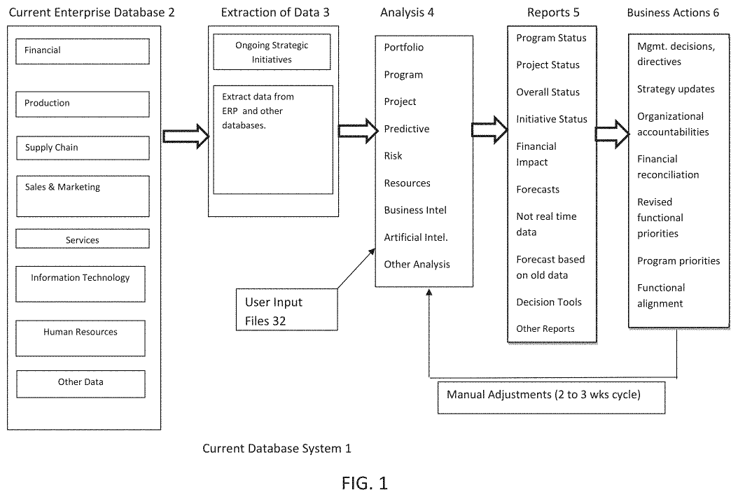

Referring to FIG. 1, in an exemplary embodiment, a current database system 1 in a current state is described and provides a current workstream of margin expansion portfolio management. For example, FIG. 1 shows a current database system 1 in a current state including a Current Enterprise Database 2, Extraction of Data 3, Analysis 4, Reports 5 and Business Actions 6. Further included, but not shown, is an optional user and an optional administrator. The user refers to the role of accessing the current database system 1. The administrator refers to the role of administering the current database system 1. These roles may be performed by the same person.

As depicted in FIG. 1, data is extracted from ERP and other databases of current enterprise database 2 including financial data, production data, supply chain data, sales & marketing data, services data, information technology data, human resources data, and other data. Current enterprise database 2 may be stored and implemented by a client computer (not shown). In the Extraction of Data 3 module, data is extracted from ERP and other databases which also includes ongoing strategic initiatives. The analysis 4 module analyzes extracted data from current enterprise database 2 and performs portfolio analysis, program analysis, project analysis, predictive analysis, risk analysis, and resource analysis. Further, a user may input user input data files 32 into the analysis module 4 for analysis by the analysis module 4. The reports 5 module provides reports and dashboards for all levels of stakeholders, in relevant format including reports of program status and project status based on the analysis from the analysis module 4. The reports may not be real time data and forecast may be based on old data. The business actions 6 module provides to the user management decisions, directives, strategy updates, organizational accountabilities, financial reconciliation, revised functional priorities, program priorities, and functional alignment based on reports from reports module 5. In the current workstream (current state) of margin expansion portfolio management, manual adjustments are typically implemented based on business actions 6 in the analysis 4, for example, in for example, two to three week cycles.

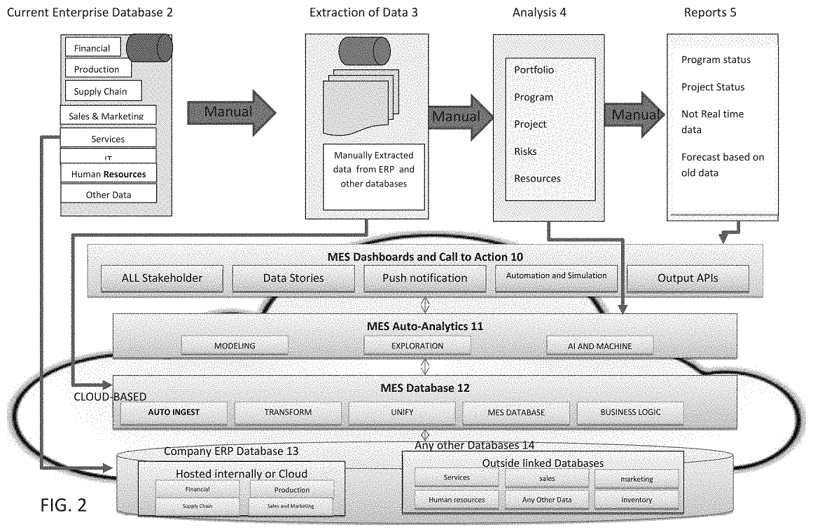

Referring to FIG. 2, in an exemplary embodiment, an integrated database system 10 is described and provides a future workstream (future state) and mapping of margin expansion portfolio management of an enterprise level data base from the current state to a future state of margin expansion portfolio management with cross functional intelligent modules for business and functional leaders to make decisions with high assurance and accuracy, dramatically improving initiative outcomes and business results. The solution may be maintained at an enterprise level. FIG. 2 further shows the mapping from the current state features of FIG. 1 reproduced in FIG. 2 to an MES Dashboard and Call to Action 10 module, MES Auto-Analytics 11 module, MES Database 12, and Company ERP Database 13.

As shown in FIG. 2, in an exemplary embodiment, with the application of proprietary algorithms and common identifiers the integrated database system 10 automatically extracts financial and operational information from at least one of the databases linked to Current Enterprise Database 2. The integrated database system 10 also populates Company ERP Database 13 which is hosted internally or in the cloud and stores Financial, Supply Chain, Production, and Sales and Marketing Data from at least one of the databases linked to Current Enterprise Database 2. The integrated database system 10 also populates outside linked databases storing services, human resources, sales, marketing, inventory, and any other data from Other databases linked to Current Enterprise Database 2. The integrated database system 10 integrates distributed database systems into one coherent database repository.

As shown in FIG. 2, the Extraction of Data 3 module of the integrated database system 10 extracts data including, for example, financial and operational information from the Company ERP database, other databases, and Current Enterprise Database 2. The extracted financial and operational information is input into a Margin Expansion Solutions (MES) Database 12 and is populated with Ongoing Strategic Initiatives Information e.g. initiative identifier, title of initiative, start and end dates, planned savings, revenue . . . etc. Further, the integrated database system 10 constantly keeps the MES Database 12 current without manual intervention. The MES Database 12 may be stored and implemented by a host computer (not shown). Further, the MES Database 12 includes an auto ingest module, transform module, unify module, business logic module, and MES database module.

As shown in FIG. 2, the Analysis 4 module analyzes manually extracted data from ERP and other databases, in a current state, stored at Current Enterprise Database 2 for Portfolio Analysis, Program Analysis, Project Analysis, Predictive Analysis, Risk Analysis, and Resource Analysis through application of Business Intelligence and/or Artificial Intelligence and is mapped to AI and Machine of MES Auto-Analytics 11, in a future state. Analysis 4 module further applies algorithms to simulate multiple outcomes with multiple resource prioritization scenarios, regression models to forecasting outcomes with, for example and non-limiting, 90% confidence and is mapped to Modeling and Exploration of MES Auto-Analytics 11, in a future state. Accordingly, after being mapped, for example, MES Auto-Analytics 11 module, in the future state, applies an MES Smart Analytics Process including Artificial Intelligence determination to provide a smart/predictive basis for senior leaders to prioritize initiatives, investments, and resources with high accuracy and assurance.

As shown in FIG. 2, reports 5 module, in a current state, provides reports and is mapped to MES dashboards and Call to Action 10, in a future state, for all levels of stakeholders, in relevant format including reports of Program Status, Project Status, Overall Status, Initiative Status, Financial Impact, Forecasts, Decision Tools, and Other. The aforementioned reports, provided by the reports 5 module, provide data and fact-based visibility formatted for project and middle managers to make early interventions and take corrective actions. Further, reports 5 module is mapped to the MES dashboards and Call to Action 10 to provide data stories, push notification, automation and simulation, and output APIs. Further still, MES dashboards and Call to Action 10 provides a high efficiency, high velocity solution that dramatically improves financial performance of the business. This solution addresses needs of multiple stake holders across the business and has customization capabilities of credible and timely information for making decisions for, for example, CFO, CEO, President, and other business leaders. Further, the MES dashboards and Call to Action 10 provides reports and findings to all stakeholders such as, for example: for innovation leaders, reports and findings of technology, marketing and innovation roadmaps; for business development leaders reports and findings of strategic portfolio enhancement; for site operation excellence (OPEX) leaders, reports and findings of cost and productivity optimization; for functional leaders, reports and findings of resource allocation, balancing supply and demand; and for project managers, reports and findings of executing and reporting. Other expected outcomes by utilizing the integrated database system 10 and providing reports by the MES dashboards and Call to Action 10 allow employees to work easier, ensure reporting/regulatory compliance, better integrate systems across locations, replace legacy processes, position company for growth, better serve customers, standardize global operations, delight shareholders, reduce working capital, and provide a competitive advantage. That is, high process efficiency and high velocity business productivity provide high percentage EBITA Impact that is previously not available. Further, MES dashboards and Call to Action 10 provides real time updates and product capabilities include automated and real time information for portfolio management; automated extraction from all databases including financial data; high database fidelity with limits of authority and automation; reporting and dashboards are customized for all stakeholder levels; objective analytics for business intelligence and AI Algorithm based Insights; portfolio status is current and in sync with enterprise DB systems; scalable deployment at enterprise level; high confidence in decision and risk management; sustainable enterprise business system and low latency of, for example, 3-5 seconds for dashboards filtering and refreshing display. Accordingly, MES implemented by the integrated database system 10 is an enterprise solution providing value to stakeholders across the board.

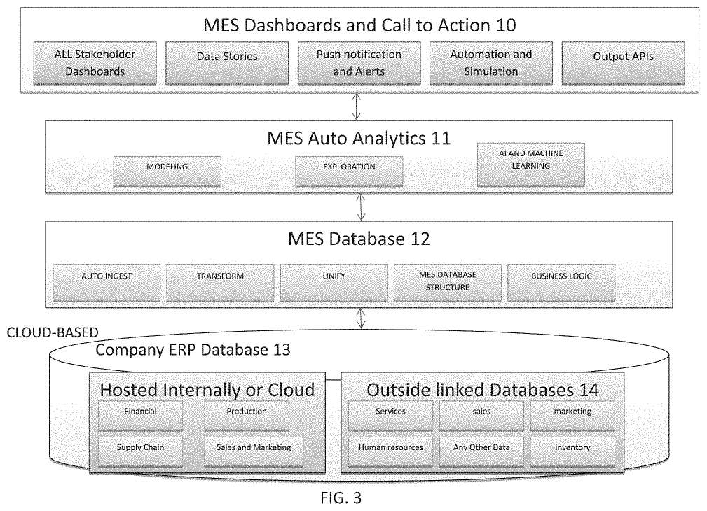

Referring to FIG. 3, in an exemplary embodiment, an integrated database system 10, in a future state, is described and provides a cloud based enterprise level data base with cross functional intelligent modules for business and functional leaders to make decisions with high assurance and accuracy, dramatically improving initiative outcomes and business results consistent with the description of FIG. 2. The proposed solutions by the integrated database system 10 may be maintained at enterprise level. Further, the integrated database system 10 constantly keeps the MES database 12 current without manual intervention.

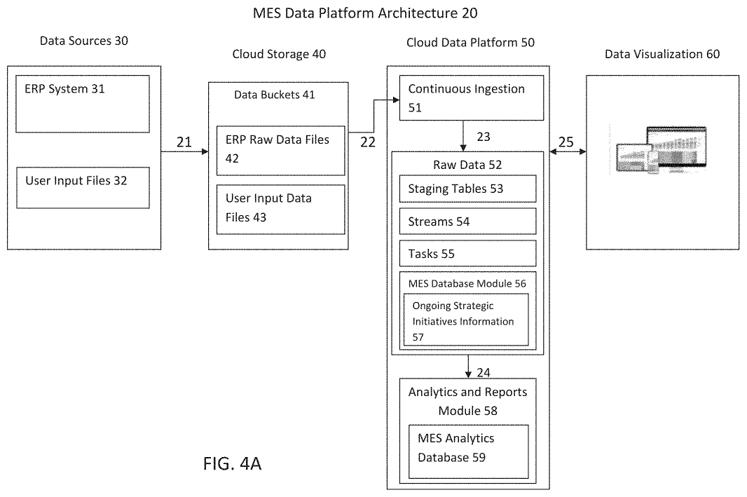

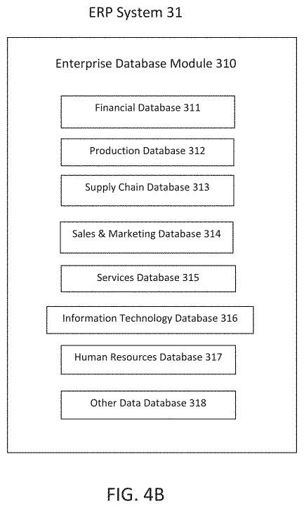

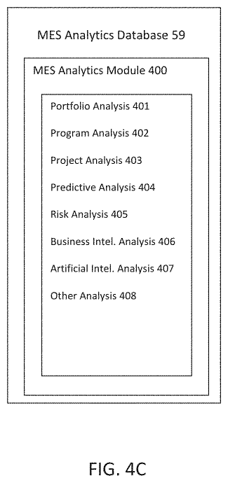

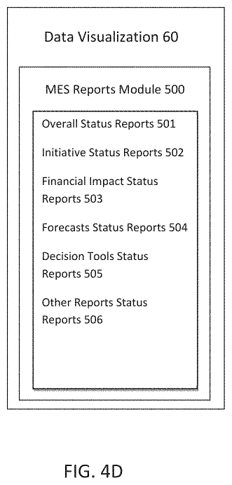

Referring to FIG. 4A, in an exemplary embodiment, an MES Data Platform Architecture 20 is described which implements the integrated database system 10 and provides an enterprise level data base with cross functional intelligent modules for business and functional leaders to make decisions with high assurance and accuracy, dramatically improving initiative outcomes and business results. Proposed solution by the integrated database system 10 may be maintained at enterprise level. FIG. 4A shows MES Data Platform Architecture 20 including Data Sources 30, Cloud Storage 40, Cloud Data Platform 50, and Data Visualization 60.

The data sources 30 include ERP System 31 and user input files 32. Data files from one or both of ERP System 31 and user input files 32 are pushed to data buckets 41 in cloud storage 40 at process 21 via a server, computer, handheld device, or similar device. The data sources 30 may be implemented by a host computer, client computer, or server.

The cloud storage 40 receives data files from one or both of ERP System 31 and user input files 32 from Data Sources 30 via push process 21. The cloud storage 40 includes data buckets 41 which store ERP raw data files 42 and user input data files 43. In an example, the data buckets 41 store objects, which consist of data and its descriptive metadata. Data buckets 41 may include different data tiers having different levels of redundancy, prices, and accessibility which each bucket may store objects from different storage tiers. Access privileges for the objects stored in a bucket may be specified and interaction with data buckets 41 may be via application programming interfaces (APIs). The cloud storage 40 may be implemented by a host computer, client computer, or server.

At process 22, a Simple Queue Service (SQS) Event Notification is setup on the data buckets 41 to send a notification over to the SQS queue in the Cloud Data Platform 50 for Continuous Ingestion 51 whenever a new data file is received. At process 23, a serverless service of the Cloud Data Platform 50 automatically loads the received raw data 52 files into staging tables 53. For example, the continuous data ingestion service of the Cloud Data Platform 50 at process 23 loads data automatically after files are added to a stage. At process 24, streams 54 capture data changes in the staging tables 53. Tasks 55 running in a set time interval i.e. every minute, merge raw data in the MES Database Module 56, execute data transformation per Ongoing Strategic Initiatives Information 57, and load data into an MES Analytics Database 59 for analytics in an Analytics and Reports module 58. One of ordinary skill in the art would recognize that the set time interval may be a minute, two minutes, five minutes, etc., and is not limited to a specific time interval. The MES Database Module 56 is populated with Ongoing Strategic Initiatives Information 57 e.g. initiative identifier, title of initiative, start and end dates, planned savings, revenue . . . etc. Further, the MES Data Platform Architecture constantly keeps the MES Database Module 56 current without manual intervention. The MES Database Module 56 may be stored and implemented by a host computer, client computer, or server. The Cloud Data Platform 50 may be implemented by a host computer, client computer, or server. Further the MES Data Platform is domain agnostic and is a cloud-based architecture which includes Cloud based operations and operates on the data cloud architecture. Thus, the MES data platform is accessible on all devices including, for example, mobile/desktop/laptop/tablets which includes an intuitive web-based user interface. The collaborative architecture leads to being global systems ready and is set up to consume data from multiple ERP systems in an enterprise with auto data ingestion capabilities. By the MES data platform having such an architecture, the MES data platform saves disk space, reduce redundancy, and ensure that data is consistent from one database to another which is an improvement over conventional data platforms. Further, such data integration of the MES data platform reduces latency and increases processing speed.

At process 25, queries in the MES analytics database 59 to retrieve data and for related dashboards are created and displayed through a data visualization 60 program. The data visualization 60 program may be implemented and displayed by a host computer, client computer, or server.

Referring to FIG. 4B, in an exemplary embodiment, the ERP System 31 is further described. ERP system 31 includes an Enterprise Database Module 310 which may be stored and implemented by a client computer, host computer, or server. With the application of proprietary algorithms and common identifiers, the MES Data Platform automatically extracts financial and operational information from at least one database of Enterprise Database Module 310 including Financial Database 311, Production Database 312, Supply Chain Database 313, Sales & Marketing Database 314, Services Database 315, Information Technology Database 316, Human Resources Database 317, and Other Data Database 318.

Referring to FIG. 4C, in an exemplary embodiment, the MES Analytics Database 59 includes MES Analytics Module 400. With application of proprietary business logic and algorithms, the MES Analytics Module 400 analyzes data stored at MES Analytics Database 59 in an MES Smart Process and Decision flow for Portfolio Analysis 401, Program Analysis 402, Project Analysis 403, Predictive Analysis 404, Risk Analysis 405, Business Intelligence Analysis 406, Artificial Intelligence Analysis 407, and/or Other Analysis 408. By applying algorithms to implement the Analyses 401-408, multiple outcomes are simulated with multiple resource prioritization scenarios, regression models to forecasting outcomes with 90% confidence. For example, MES Analytics Module 400 applies Artificial Intelligence Analysis 407 determination to provide a smart/predictive basis for senior leaders to prioritize initiatives, investments, and resources with high accuracy and assurance. By the MES Analytics Module 400 having such an architecture, hierarchy, and organization to apply business logic and algorithms, the MES Analytics Module 400 saves disk space, reduce redundancy, and increases processing speed of the analysis of the MES Analytics Database as compared to conventional data platforms.

Referring to FIG. 4D, in an exemplary embodiment, the Data Visualization 60 includes MES Reports Module 500 which provides reports and dashboards for all levels of stakeholders, in relevant format including Overall Status Reports 501, Initiative Status Reports 502, Financial Impact Reports 503, Forecasts Status Reports 504, Decision Tools Reports 505, and Other Reports 506. The reports 501-506 generated by the MES Reports Module 500, provides data and fact-based visibility formatted for project and middle managers to make early interventions and take corrective actions. This high efficiency, high velocity solution dramatically improves financial performance of the business by reducing the latency of report production and visualization of conventional dashboards. This solution addresses needs of multiple stake holders across the business and has customization capabilities of credible and timely information for making decisions for CFO, CEO, President, and other business leaders. For example, MES Reports Module 500 provides reports and findings to: Innovation leaders—technology, marketing, and innovation roadmaps; Business development leaders—strategic portfolio enhancement; Site Operation Excellence (OPEX) leaders—cost and productivity optimization; Functional leaders—resource allocation, balancing supply and demand; and Project Managers—executing and reporting. Other expected outcomes by utilizing the integrated database system 10 and providing reports by the MES Reports Module 500 allow employees to work easier, ensure reporting/regulatory compliance, better integrate systems across locations, replace legacy processes, position company for growth, better serve customers, standardize global operations, delight shareholders, reduce working capital, and provide a competitive advantage. That is, high process efficiency and high velocity business productivity provide high percentage EBITA Impact and saves disk space and reduces latency of visualization.

Further, in an exemplary embodiment of FIG. 4D, MES dashboards created by queries and provided by the MES dashboard module are displayed through the data visualization 60 program on a device, for example, display, monitor, tablet, or phone. An MES dashboard may show Financials, Trends, and Risks. The MES dashboards may provide real time, direct access to accurate information with predictive management indicators supplied by the MES analytics module as described above. For example, MES analytics module provide via the MES dashboards visible realistic, high confidence targets, with early warnings and corrective actions to maintain course. The early warning corresponds to the “Alert to the CEO” from the MES analytics module and corrections actions include the “Recommend to CEO” as provided by the MES analytics module. The system provides relevant dashboards to different executives and enables stakeholders, leadership, and their staff to avoid surprise cloud bursts and bumpy roller coaster performance. For example, customized dashboards are provided for each stakeholder including executive summaries, forecasts, trends, risks, and recommended actions as analyzed and determined by the M ES analytics module. This provides financial rigor for real time visibility to the current status and reports of the organization as produced by MES analytics module and displayed on the MES dashboards. Accordingly, MES is an enterprise solution providing value to stakeholders across the board.

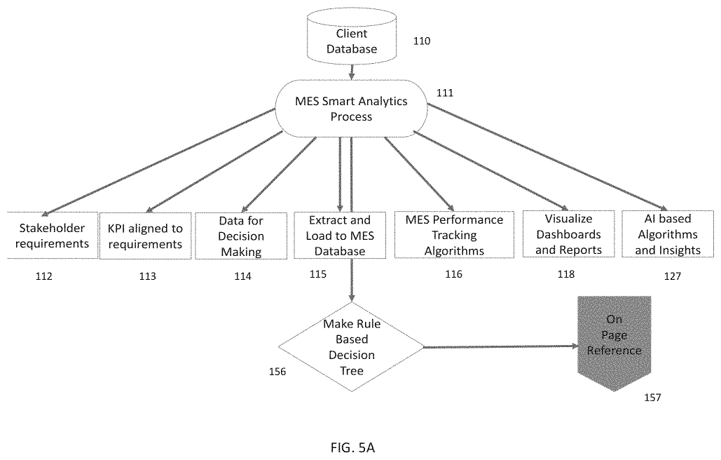

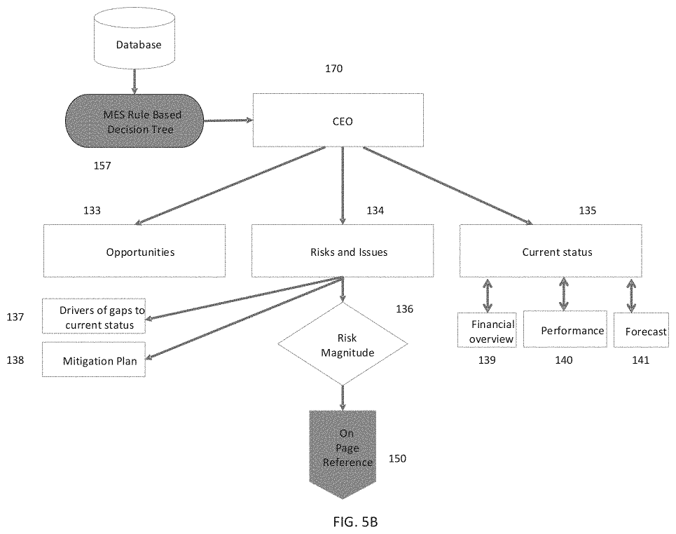

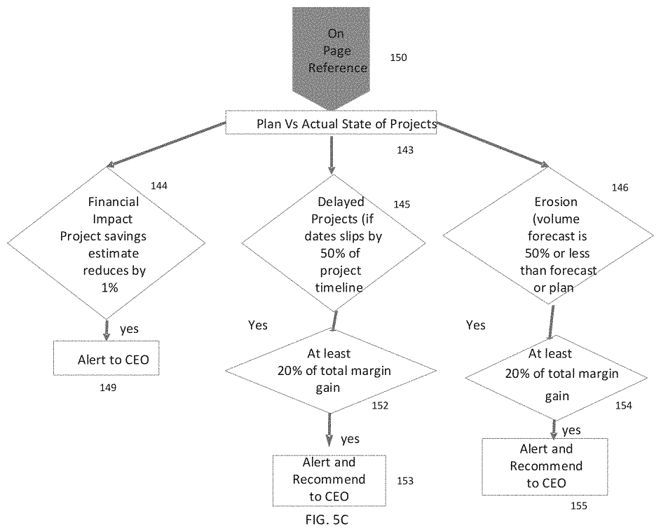

Referring to FIGS. 5A-5C, in an exemplary embodiment, Analysis 4 in FIG. 1, MES Auto-Analytics 11 in FIG. 2, and MES Auto-Analytics 11 in FIG. 3, Analytics and Reports Module 58 in FIG. 4A, and the MES Smart Analytic Process as applied by the MES Analytics Module 400 in FIG. 4C is further described in FIGS. 5A-5C. As shown in FIG. 5A, the MES Smart Analytics Process 111 defines key stakeholder requirements and identify Key Performance Indicators (KPI) aligned to the defined stakeholder requirements 113 for a selected stakeholder, for example, CEO, CFO, CTO, etc. The MES Smart Analytics Process defines the best way to quantify or qualify the key stakeholder requirements 112 for the selected stakeholder. The MES Smart Analytics Process then locates and accesses the source of data, from the client database, that informs Decision-Making (data for decision making) 114. The located and accessed data is then extracted and loaded to the MES Database 115. The MES Smart Analytics Process then deploys MES performance—tracking algorithms 116 and develops customer-specific algorithms as needed 117. To develop the customer-specific algorithms, the MES Smart Analytics Process determines decision criteria, creating decision rules, assessing performance to objectives, and identifying program risks 154 (not shown) as part of an MES Rule-Based Decision Tree 156 for the selected stakeholder. This includes identifying or determining top financial performers, worst financial performers, project cycle time, performance gap analysis, quantified magnitude of risk, and risk mitigation plans/opportunities for alerting or recommending projects to management or executive officers. Further still, in the MES Smart Analytics Process, the MES Analytics Module 400 develops rules for sorting the outcomes 158 by: function, project, region, business unit, plant, department, highest risk, financial impact, cycle time, and other factors (not shown) 131. Further still, in the MES Smart Analytics Process, the MES Analytics Module 400 visualizes outcomes categorized into financials, trends, risks, and insights and provided in dashboards and reports (visualize dashboards and reports) 118. This MES Smart Analytics Process may be repeated for each stakeholder, for example: CEO, CTO, CFO, etc., to provide specific insights and outputs relevant to each stakeholder.

Further, the MES Smart Analytics Process provides Al-driven alerts and insights that inform decision-making 127 and recommends actions / insights that inform (not shown) 159. Further, the MES smart analytics process visualizes dashboards 118 and produces reports AI based Algorithms and Insights 120. Further still, the MES Analytics Module 400 determines the MES Smart Analytics Process 111 which makes the MES Product Decision Tree.

As shown in FIG. 5B, for example, in implementing the rule-based decision tree 157 by the MES Analytics Module 400 tailored to a specific stakeholder, a user (CEO) 170 is prompted to make a selection to enter an MES Smart Analytics Process or Management/Executive Officer inquiry process, i.e. “What does CEO want to know?” If the user chooses the MES Smart Analytics Process 111, the MES Analytics Module 400 implements the above noted features as described in relation to FIG. 5A.

The MES Smart Analytics Process queries the user/CEO 170 and prompts the user to choose the “What does CEO want to know?” i.e. the Management/Executive Officer inquiry process. The MES Analytics Module 400 accesses the MES database for data to analyze and provides three main categories for the user including opportunities 133, risks and issues 134, and current status 135 inquiry. If the CEO (user) 170 would like to know the current status of the enterprise or company, an inquiry is made to the current status 135 category, and the MES Analytics Module 400 produces at least one of a financial overview 139, performance to plan 140, and forecast going forward 141 depending on the CEO's choice. The CEO may also make an inquiry for current opportunities 133 which the MES Analytics Module 400 produces. Further, the CEO may make an inquiry of risks and issues 134 the company or enterprise may face. Responding to the inquiry of risks and issues 134, the MES Analytics Module 400 provides four main categories including: answers to the questions of “What are they (risks and issues)” and “Where are they (risks and issues)” 135, magnitude of risk 136, drivers of gaps to current status 137, and mitigation plan 138. Further, the MES Analytics Module 400 determines that drivers of gaps to current status 141 are provided based on the enterprise/company's expertise or from the data 142.

As shown in FIG. 5C, under the risk magnitude 136, the M ES Analytics Module 400 also determines plan vs actual state of projects 143 which includes three main categories: financial impact 144, delayed projects 145, and erosion 146.

In determining the financial impact 144, the MES Analytics Module 400 bases its decision on project level, regional goals, spend, project timelines, and resources in an aggregate view. As shown in FIG. 5C, if the MES Analytics Module 400 determines the financial impact based on these factors have, for example, project savings estimate reductions by a predetermined amount, for example, 1% at 144, an alert is sent to the CEO for proactive interventions and corrective actions at 149. The project saving estimate reduction percentage is exemplary and may be higher or lower than 1% depending on the project and/or leadership's determination.

In determining the delayed projects 145, the MES Analytics Module 400 bases its decision on milestones including start date, planned completion date, and current status. If the MES Analytics Module 400 determines that the timing (dates) slip by a predetermined amount, for example, 50% of project timeline (including magnitude) at 145, then the MES Analytics Module 400 proceeds to determine whether there is at least a predetermined amount, for example, a 20% savings reduction (at least 20% of total margin gain 152). If the MES Analytics Module 400 determines that Projects have the savings reduction of at least a predetermined amount, for example, 20% of the total margin expansion annual plan at 152, then the MES Analytics Module 400 alerts the CEO and provides a recommendation at 153. The project savings percentage is exemplary and may be higher or lower than 20% depending on the project and/or leadership's determination. The recommendations to the CEO may include a check status of specific “named” projects, assess resource allocation, and “ask what decisions are required to move forward.

In determining Erosion 146, the MES Analytics Module 400 bases its decision due to, for example, volume, cost, market conditions, scope, and investment at 146. Regarding Erosion 146, if the MES Analytics Module 400 determines that the actual volume is, for example, 50% or less than forecast or plan at 146, then the MES Analytics Module 400 proceeds to determine whether there is at least, for example, a 20% savings reduction, i.e. determine whether projects with contribution of at least 20% of the total margin expansion annual plan at 154. If the MES Analytics Module 400 determines that Projects have the savings of at least, for example, 20% of the total margin expansion annual plan or the savings are at least, for example, 20% of the total savings (total margin gain) at 154, then the MES Analytics Module 400 alerts the CEO and provides a recommendation at 155. The project savings percentage is exemplary and may be higher or lower than 20% depending on the project and/or leadership's determination. In the recommendation, the MES Analytics Module 400 either checks status of specific “Named” projects, or the MES Analytics Module 400 seeks offsetting projects including: highlight the volume issue; inquires “what does benchmarks and history tell us?”; accelerate projects with planned completion in the next 6 months; accelerate projects with contribution of at least 20% of the total margin expansion annual plan; and/or inform CEO of the benefits of projects acceleration. For example, the MES Analytics Module may determine which projects are below expectations and provide recommendations to leadership to find other projects which can offset the loss from the underperforming projects which are causing the erosion.

Further regarding Erosion 146, in another example, if the MES Analytics Module 400 determines increased component costs and projects with contribution of at least 20% of the total margin expansion annual plan, the MES Analytics Module 400 highlights the concern as a gap driver and makes a recommendation for the CEO. MES Module monitoring enables early intervention in erosion of savings due to unrealistic target setting. For example, in a particular project the MES Analytics Module 400 recognizes certain cost savings. If there is an increased component cost though, there is a drop in volume and thereby a loss of savings. In this case, the MES Analytics Module 400 identifies and reports the increased component cost leading to erosion and the loss of cost savings. The MES Analytics Module 400 may then seek new projects to offset the losses due to erosion and provide new project recommendations to the leadership.

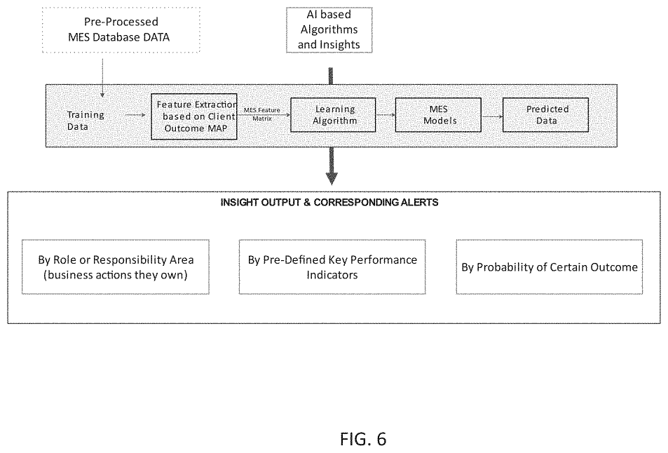

Referring to FIG. 6, in an exemplary embodiment, the Artificial Intelligence based algorithms and insights module 127 of FIG. 5a is further described for artificial intelligence and predictive machine learning process as learned, trained, utilized, and/or applied by the MES Smart Analytics Process 111 module. As shown in FIG. 6, pre-processed MES Database data is input as training data for AI based algorithms and Insights. Next, business rules in the MES Database training data are extracted based on a Client Outcome MAP. The extracted features are input in an MES Feature Matrix and through application of the Learning Algorithm, MES Models are created which produces Predicted Data for artificial intelligence and predictive machine learning process. Further, as shown in FIG. 6, the Artificial Intelligence module applies to not only the Learning Algorithm, but throughout training process to output to the Insight Output & Corresponding Alerts module. Further application of the AI based algorithms and Insights creates Insight Output and Corresponding Alerts which are, for example, a) by role or responsibility area (business actions they own), b) by pre-defined key performance indicators, and c) by probability of certain outcome.

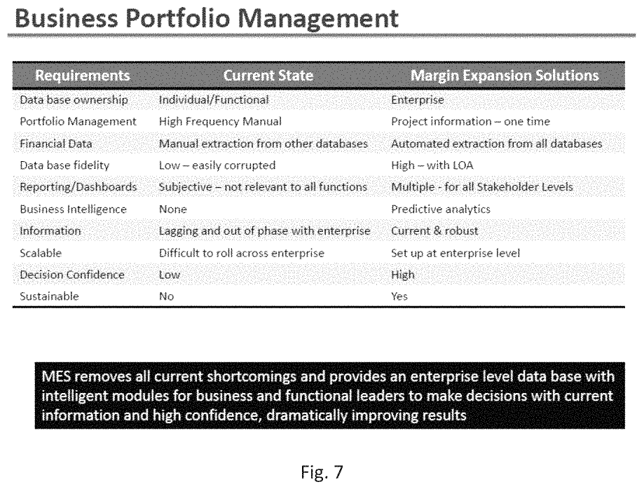

Referring to FIG. 7, in an exemplary embodiment, a business portfolio management chart shows current requirements, current state of business process and tools and the MES provided by implementing the integrated database system 10 as described in FIG. 3. That is, MES implemented by the integrated database system 10 removes all current shortcomings and provides an enterprise level data base with intelligent modules for business and functional leaders to make decisions with current information and high confidence, dramatically improving results. For example, the requirement of Data base ownership has a current state of Individual/Functional, while the MES provided by implementing the integrated database system 10 provides Enterprise. The requirement of Portfolio Management has a current state of High Frequency managed manually, while the MES provided by implementing the integrated database system 10 provides automatic management after one time entry of Project information. The requirement of Financial Data has a current state of Manual extraction from other databases, while the MES provided by implementing the integrated database system 10 provides automated extraction from all databases. The requirement of Data base fidelity has a current state of Low—easily corrupted, while the MES provided by implementing the integrated database system 10 provides High—with Limits of Authority. The requirement of Reporting/Dashboards has a current state of Subjective and not relevant to all functions, while the MES provided by implementing the integrated database system 10, provides Multiple and for all Stakeholder Levels. The requirement of Business Intelligence has a current state of none, while the MES provided by implementing the integrated database system 10 provides Predictive and prescriptive analytics. The requirement of Information has a current state of Lagging and out of phase with enterprise, while the MES provided by implementing the integrated database system 10, is current and robust. The requirement of Scalable has a current state of Difficult to roll across enterprise, while the MES provided by implementing the integrated database system 10 provides Setup at enterprise level. The requirement of Decision Confidence has a current state of Low, while the MES provided by implementing the integrated database system 10 provides High. The requirement of Sustainable has a current state of No, while the MES provided by implementing the integrated database system 10 provides for sustainability (Yes).

The Integrated database system 10 of the present application may be implemented by any hardware, software or a combination of hardware and software having the above-described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present application, as well as the hardware, software, and the combination thereof.

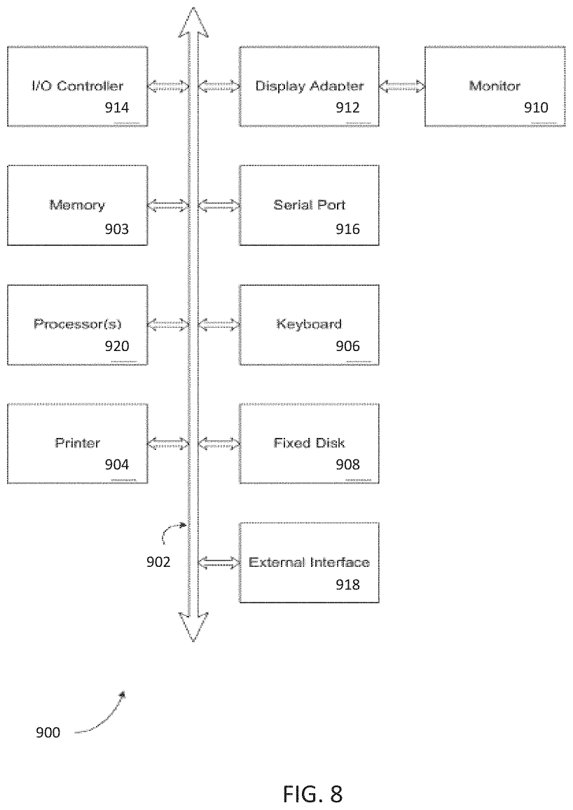

In accordance with one embodiment of the invention, the system, apparatus, methods, processes, functions, and/or operations for enabling effective use of the Integrated database system 10 may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 8 is a diagram illustrating elements or components that may be present in a computer device or system 900 configured to implement a method, process, function, or operation in accordance with an embodiment of the present application. The subsystems shown in FIG. 8 are interconnected via a system bus 902. Additional subsystems include a printer 904, a keyboard 906, a fixed disk 908, and a monitor 910, which is coupled to a display adapter 912. Peripherals and input/output (I/O) devices, which couple to an I/O controller 914, can be connected to the computer system by any number of means known in the art, such as a serial port 916. For example, the serial port 916 or an external interface 918 can be utilized to connect the computer device 900 to further devices and/or systems not shown in FIG. 8 including a wide area network such as the Internet, a mouse input device, and/or a scanner. The interconnection via the system bus 902 allows one or more processors 920 to communicate with each subsystem and to control the execution of instructions that may be stored in a system memory 922 and/or the fixed disk 908, as well as the exchange of information between subsystems. The system memory 922 and/or the fixed disk 908 may embody a tangible and/or non-transitory computer-readable medium.

It should be understood that the present application as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the application have been described for illustrative and not restrictive purposes, and alternative embodiments will become apparent to readers of this application. Accordingly, the present invention is not limited to the embodiments described above or depicted in the drawings, and various embodiments and modifications can be made without departing from the scope of the claims below.

While specific embodiments and examples of the present application have been described, various modifications, combinations, and substitutions may be made to such embodiments and examples. Such modifications and substitutions are within the scope of the present application, and are intended to be covered by the following claims.

1. An integrated database system for margin expansion solution, the integrated database system comprising:
a client computer;
a host computer communicatively connected to the client computer;
an enterprise database accessible by the client computer, the enterprise database storing business data;
a margin expansion solutions (MES) database populated by automatically extracted data from the enterprise database by a data extraction module, and further populated with ongoing initiatives information, wherein financial and operational data is automatically extracted from business data of the enterprise database according to the ongoing initiatives information;
an analytics module that analyzes the extracted financial and operational data; and
a reports module that provides reports and dashboards for a user in a relevant format based on the analyzed financial and operational data;
wherein the integrated database system has ubiquitous access which reduces an amount of time required for information gathering, formatting, analyzing and reporting, from a manual process to an automated process with real time reports and dashboards, including predictive and prescriptive insights.

2. The integrated database system of claim 1, wherein the manual process to the automated process is through an artificial intelligence and predictive machine learning process.

3. The integrated database system of claim 2, wherein the artificial intelligence and predictive machine learning process includes pre-processed M ES Database data input as training data for AI based algorithms and Insights.

4. The integrated database system of claim 3, wherein business rules in the MES Database training data are extracted based on a Client Outcome MAP and input in an MES Feature Matrix.

5. The integrated database system of claim 4, wherein through application of a learning algorithm, MES models are created which produces predicted data for the artificial intelligence and predictive machine learning process.

6. The integrated database system of claim 1,
wherein the MES database is automatically updated with the extracted financial and operational data without manual intervention,
wherein the analytics module implements an analytics application to analyze the extracted financial and operational data,
wherein the analytics application includes at least one of: portfolio analysis, program analysis, project analysis, predictive analysis, risk analysis, business intelligence analysis, artificial intelligence analysis,
wherein the analytics module outputs the analyzed financial and operational data to the reports module, and
wherein the reports module further provides data and fact-based visibility in an accessible format for the user to make early interventions and take corrective actions.

7. The integrated database system of claim 6, wherein the analytics application includes an artificial intelligence application module to provide a smart/predictive basis for the user to prioritize initiatives, investments, and resources with high accuracy and assurance.

8. A method for margin expansion solution by an integrated database system, the method comprising:
inputting, by a client computer, business data into an enterprise database;
populating, by a host computer, a margin expansion solutions (MES) database with ongoing initiatives information;
extracting, by a data extraction module, data from the enterprise database and populating the MES database;
extracting automatically, by the MES database, financial and operational data from the business data of the enterprise database according to the ongoing initiatives information;
analyzing, by an analytics module, the extracted financial and operational data; and
providing, by a reports module, reports and dashboards for a user in a relevant format based on the analyzed financial and operational data;
wherein the integrated database system has ubiquitous access which reduces an amount of time required for information gathering, formatting, analyzing and reporting, from a manual process to an automated process with real time reports and dashboards, including predictive and prescriptive insights.

9. The method of claim 8, wherein the manual process to the automated process is through an artificial intelligence and predictive machine learning process.

10. The method of claim 9, wherein the artificial intelligence and predictive machine learning process includes pre-processed MES Database data input as training data for AI based algorithms and Insights.

11. The method of claim 10, wherein business rules in the MES Database training data are extracted based on a Client Outcome MAP and input in an MES Feature Matrix.

12. The method of claim 11, wherein through application of a learning algorithm, M ES models are created which produces predicted data for the artificial intelligence and predictive machine learning process.

13. The method of claim 8, further comprising:
automatically updating the MES database with the extracted financial and operational data without manual intervention;
implementing, by the analytics module, an analytics application to analyze the extracted financial and operational data,
wherein the analytics application includes at least one of: portfolio analysis, program analysis, project analysis, predictive analysis, risk analysis, business intelligence analysis, artificial intelligence analysis;
outputting, by the analytics module, the analyzed financial and operational data to the reports module;
providing, by the reports module, data and fact-based visibility in an accessible format for the user to make early interventions and take corrective actions.

14. The method of claim 13, wherein the analytics application includes an artificial intelligence application module to provide a smart/predictive basis for the user to prioritize initiatives, investments, and resources with high accuracy and assurance.

15. A margin expansion solution (MES) data platform architecture system, the MES data platform architecture system comprising:
a client computer including a database source;
a host computer including cloud storage, the host computer communicatively connected to the client computer;
a cloud data platform accessible by the host computer, the cloud data platform storing business data, wherein the cloud data platform includes:
staging tables, streams, and tasks, and
an MES database module populated with ongoing initiatives information, wherein financial and operational data is automatically extracted from the business data of the enterprise database according to the ongoing initiatives information, and wherein the MES database module is kept current without manual intervention,
an analytics module that analyzes the extracted financial and operational data, and
a reports module that provides reports and dashboards for a user in a relevant format based on the analyzed financial and operational data; and
a data visualization module that displays the reports and dashboards;
wherein the MES data platform architecture system has ubiquitous access which reduces an amount of time required for information gathering, formatting, analyzing and reporting, from a manual process to an automated process with real time reports and dashboards, including predictive and prescriptive insights.

16. The MES data platform architecture system of claim 15,
wherein the cloud storage receives data files from one or both of an Enterprise Resource Planning (ERP) system and user input files from the Data Sources via a push process, and
wherein the cloud storage includes data buckets which store ERP raw data files and the user input data files.

17. The MES data platform architecture system of claim 16, wherein a Simple Queue Service (SQS) event notification is setup on the data buckets to send a notification over to an SQS queue in the cloud data platform for continuous data ingestion service in response to a new data file being received.

18. The MES data platform architecture system of claim 17,
wherein a serverless service of the cloud data platform automatically loads the received raw data files into the staging tables, and
wherein the continuous data ingestion service of the cloud data platform loads data automatically after files are added to a stage.

19. The MES data platform architecture system of claim 18,
wherein the streams capture data changes in the staging tables,
wherein the tasks run in a predetermined time interval,
wherein the MES database module is configured to merge raw data, execute data transformation per the ongoing strategic initiatives information, and load data into the MES analytics database for analytics in the analytics and reports module.

20. The MES data platform architecture system of claim 19, wherein queries against views in the MES analytics database retrieve data when executed and related dashboards are created and displayed through the data visualization module.
